(19) United States
(12) Patent Application Publication
(10) Pub. No.: US 2024/0430908 A1
(43) Pub. Date: Dec. 26, 2024

(54) Semi-Persistent Physical Downlink Control Channel (PDCCH)

(71) Applicant: TELEFONAKTIEBOLAGET LM ERICSSON (PUBL), Stockholm (SE)

(72) Inventors: Ying Sun, Täby (SE); Du Ho Kang, Sollentuna (SE); Jose Luis Pradas, Stockholm (SE); Kittipong Kittichokechai, Järfälla (SE)

(21) Appl. No.: 18/699,517

(22) PCT Filed: Oct. 17, 2022
(86) PCT No.: PCT/IB2022/059950

§ 371 Date: Apr. 8, 2024

Related U.S. Application Data
(60) Provisional application No. 63/270,611, filed on Oct. 22, 2021.

(51) Int. Cl. H04W 72/232; H04W 52/02; H04W 72/11

(52) U.S. Cl. CPC H04W 72/232; H04W 52/0225; H04W 72/11

(57) ABSTRACT

Embodiments include methods for a user equipment (UE) configured to operate in a wireless network according to a discontinuous reception (DRX) configuration comprising periodic DRX on durations. Such method include awakening for a first duration from a low energy consumption state. The first duration is outside of the periodic DRX on durations, or within but shorter than one of the periodic DRX on durations. Such methods include. during the first duration, monitoring a semi-persistent physical downlink control channel (SP-PDCCH) from the wireless network for downlink control information (DO) intended for the UE. Other embodiments include complementary methods for a network node. as well as UEs and network nodes configured to perform such methods.

### TECHNICAL FIELD

The present disclosure generally relates to wireless communication networks, and more specifically to discontinuous reception (DRX) techniques for reducing wireless device energy consumption for applications or services (e.g., extended reality) needing guaranteed low latency.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

FIG. 2 shows a high-level view of an exemplary 5G network architecture, including NG-RAN 299 and 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to 5GC 298, more specifically to the Access and Mobility Management Functions (AMFs, e.g., 230a,b) via respective NG-C interfaces and to the User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is possible that one NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. Time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz or even larger for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE.

In NR, UL and DL data transmissions can occur with or without an explicit grant or assignment of resources by the network (e.g., gNB). In general, UL transmissions are often referred to as occurring on resources “granted” by the network (i.e., “UL grant”), while DL transmissions are often referred to as occurring on resources “assigned” by the network (i.e., “DL assignment”). In case of an explicit grant/assignment, downlink control information (DCI) is sent to the UE informing it of specific radio resources to be used for the transmission.

In contrast, a transmission without explicit grant/assignment is often configured to occur with a defined periodicity. Given a periodic and/or recurring UL grant and/or DL assignment, the UE can then initiate a data transmission and/or receive data according to a predefined configuration. Such transmissions can be referred to as semi-persistent scheduling (SPS, for DL), configured grant (CG, for UL), or grant-free transmissions.

Extended Reality (XR) and Cloud Gaming are some important media applications under consideration for 5G. XR is an umbrella term that refers to all real-and-virtual combined environments and human-machine interactions generated by computer technology and wearables. It includes exemplary forms such as Augmented Reality (AR), Mixed Reality (MR), and Virtual Reality (VR), as well as various other types that span or sit between these examples. In the following, the term “XR” also refers to cloud gaming and related applications.

Edge Computing (EC) is an important network architecture enabler for XR. In general, EC facilitates deployment of cloud computing capabilities and service environments close to the cellular radio access network (RAN). It can provide lower latency and higher bandwidth for user-plane (UP, e.g., data) traffic, as well as reduced backhaul traffic to the 5GC. 3GPP is also studying a new application architecture for enabling Edge Applications, as described further in 3GPP TR 23.758 (v17.0.0). Edge Applications are expected to take advantage of the low latencies enabled by 5G and EC network architecture to reduce the end-to-end application-level latencies.

Device energy consumption is an important requirement for XR, cloud gaming, and similar services requiring low latency. Cloud gaming devices are expected to include smartphones or tablets. In addition to smartphones, XR experience is expected to be delivered via Head Mounted Displays (HMDs) such as augmented reality (AR) glasses. AR glasses can have an embedded 5G modem providing 5G connectivity, or the AR glasses can be tethered (e.g., via USB, Bluetooth, or WiFi) to a UE that has 5G connectivity. In some cases, AR computation can be split between the AR glasses and Edge servers, which can reduce the overall device energy consumption if traffic due to the computation split does not increase device energy consumption significantly.

In both cases, the UE's 5G connection must carry AR application traffic and UE energy consumption due to that traffic has a significant bearing on the commercial viability of AR devices. For example, if AR glasses are worn for long durations like prescription glasses, their power usage (i.e., energy/time) may need to be significantly lower than that of a smartphone.

### SUMMARY

However, existing techniques for data scheduling are inadequate for services or applications (e.g., XR) that produce periodic, non-deterministic traffic with occasional arrival time jitter, have strict latency requirements, and are run on devices need strict management of energy consumption.

Embodiments of the present disclosure provide specific improvements to communication between UEs and network nodes in a wireless network, such as by providing, enabling, and/or facilitating solutions to overcome exemplary problems summarized above and described in more detail below.

Embodiments include methods (e.g., procedures) for a UE (e.g., wireless device) configured to operate in a wireless network (e.g., E-UTRAN, NG-RAN) according to a DRX configuration that includes periodic DRX on durations.

These exemplary methods can include awakening for at least a first duration from a low energy consumption state. The first duration is outside of the periodic DRX on durations, or within but shorter than one of the periodic DRX on durations. These exemplary methods can also include, during the first duration, monitoring a semi-persistent physical downlink control channel (SP-PDCCH) from the wireless network for downlink control information (DCI) intended for the UE.

In some embodiments, the monitoring is performed on a first search space associated with SP-PDCCH. In some of these embodiments, the first search space is distinct from a second search space associated with a second PDCCH that is not a SP-PDCCH and these exemplary methods can also include monitoring the second PDCCH in the second search space. In different variants, monitoring the second PDCCH can be performed according to one of the following:
during the first duration, which is within but shorter than one of the UE's periodic DRX on durations; or
during the periodic DRX on durations, with the first duration being outside of the periodic DRX on durations.

In some embodiments, these exemplary methods can also include detecting DCI intended for the UE based on the monitoring during the first duration. In some embodiments, these exemplary methods can also include, during the first duration, receiving DL data or transmitting UL data using resources indicated by the DCI and returning to the low energy consumption state after completion of receiving DL data or transmitting UL data in accordance with the DCI.

In some embodiments, returning to the low energy consumption state after completion of the receiving or transmitting is selective based on a first condition being met. The first condition is one of the following:
a cyclic redundancy check (CRC) of the DCI is scrambled by a radio network temporary identifier (RNTI) associated with SP-PDCCH;
the DCI is detected in a search space associated with SP-PDCCH; or
a field in the DCI that indicates for the UE to return to the low energy consumption state after completion of receiving DL data or transmitting UL data in accordance with the DCI.

In some variants of these embodiments, when the first condition is not met, the first duration is at least as long as one of the periodic DRX on durations. In some variants of these embodiments, these exemplary methods can also include, based on detecting the DCI during the first duration, refraining from activating an inactivity timer associated with the DRX configuration. In some further variants, refraining from activating the inactivity timer is further based on a second condition being met, with the second condition being one of the following:
the first duration is outside of the periodic DRX on durations,
a CRC of the DCI is scrambled by an RNTI associated with SP-PDCCH,
the DCI is detected in a search space associated with SP-PDCCH, or
a field in the DCI that indicates for the UE to refrain from activating the inactivity timer.

In some further variants, refraining from activating an inactivity timer associated with the DRX configuration can include activating a further timer instead of the inactivity timer associated with the DRX configuration. In such case, returning to the low energy consumption state after completion of the receiving or transmitting can include returning to the low energy upon expiration of the further timer.

In some further variants, the first duration includes a plurality of PDCCH monitoring occasions (MOs) and the DCI intended for the UE is detected during an initial one of the PDCCH MOs. Also, these exemplary methods also include can return to the low energy consumption state and refraining from monitoring the SP-PDCCH during a subsequent one or more of the PDCCH MOs. In some further variants, the plurality of PDCCH MOs include at least the following:
a first PDCCH MO corresponding to timing of DCI that schedules data traffic that arrives early relative to a traffic period;
a second PDCCH MO corresponding to timing of DCI that schedules data traffic that arrives on-time relative to the traffic period; and
a third PDCCH MO corresponding to timing of DCI that schedules data traffic that arrives late relative to the traffic period.

In some further variants, these exemplary methods can also include receiving from the wireless network a PDCCH monitoring configuration including indications of one or more of the following:
a traffic period between successive arrivals of data traffic scheduled by PDCCH;
an offset of an initial PDCCH MO from the start of each traffic period;
a gap between successive PDCCH MOs within each traffic period; and
a duration of the plurality of PDCCH MOs within each traffic period.
   In such variants, monitoring the SP-PDCCH during the first duration can be based on the PDCCH monitoring configuration.

Other embodiments include exemplary methods (e.g., procedures) for a network node (e.g., base station, eNB, gNB, ng-eNB, etc., or component thereof) of a wireless network (e.g., E-UTRAN, NG-RAN) to communicate with a UE configured to operate according to a DRX configuration comprising periodic DRX on durations.

These exemplary methods can include, during a first duration, transmitting a SP-PDCCH containing DCI intended for the UE. The first duration is outside of the UE's periodic DRX on durations or within but shorter than one of the UE's periodic DRX on durations.

In some embodiments, the SP-PDCCH containing the DCI is transmitted in a first search space associated with an SP-PDCCH. In some of these embodiments, the first search space is distinct from a second search space associated with a second PDCCH that is not a SP-PDCCH, and these exemplary methods also include transmitting the second PDCCH in the second search space. In different variants, the second PDCCH is transmitted according to one of the following:
during the first duration, which is within but shorter than one of the UE's periodic DRX on durations; or
during the periodic DRX on durations, with the first duration being outside of the UE's periodic DRX on durations.

In some embodiments, the DCI indicates resources for UE reception of DL data or UE transmission of UL data, and these exemplary methods also include, during the first duration, transmitting DL data to or receiving UL data from the UE using the resources indicated by the DCI.

In some of these embodiments, these exemplary methods can also indicating for the UE to return to a low energy consumption state after completion of the receiving or transmitting, which can be based on one of the following:
a CRC of the DCI is scrambled by an RNTI associated with SP-PDCCH;
the DCI is detected in a search space associated with SP-PDCCH; or
an indication in a field of the DCI.

In other of these embodiments, these exemplary methods can also include indicating for the UE to refrain from activating an inactivity timer associated with the DRX configuration upon detecting the DCI, based on one of the following:
the first duration is outside of the periodic DRX on durations,
a CRC of the DCI is scrambled by an RNTI associated with SP-PDCCH,
the DCI is detected in a search space associated with SP-PDCCH, or
an indication in a field of the DCI.

In other of these embodiments, the first duration includes a plurality of PDCCH MOs, including at least the following:
a first PDCCH MO corresponding to timing of DCI that schedules data traffic that arrives early relative to a traffic period;
a second PDCCH MO corresponding to timing of DCI that schedules data traffic that arrives on-time relative to the traffic period; and
a third PDCCH MO corresponding to timing of DCI that schedules data traffic that arrives late relative to the traffic period.

In some variants of these embodiments, these exemplary methods can also include transmitting to the UE a PDCCH monitoring configuration including indications of one or more of the following:
a traffic period between successive arrivals of data traffic scheduled by PDCCH;
an offset of an initial PDCCH MO from the start of each traffic period;
a gap between successive PDCCH MOs within each traffic period; and
a duration of the plurality of PDCCH MOs within each traffic period.
   In such variants, transmitting SP-PDCCH during the first duration can be based on the PDCCH monitoring configuration.

Other embodiments include UEs (e.g., wireless devices) and network nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or network nodes to perform operations corresponding to any of the exemplary methods described herein.

These and other embodiments described herein can support data traffic having strict latency requirements with generally periodic packet arrival times and but varied packet size. Moreover, embodiments can reduce UE energy consumption for such traffic, e.g., by optimizing the amount of time the UE is awake. Additionally, embodiments can reduce PDCCH and/or MAC CE overhead to optimize DRX operations dynamically and allocate resources for varying application packet size. More generally, these techniques can facilitate more efficient usage of available transmission resources, energy-efficient UE operation via DRX, and improved quality-of-experience for users of various applications (including XR and cloud gaming applications) due to reduced UL or DL transmission latency.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 illustrates a comparison of various characteristics or requirements between Extended Reality (XR) and other 5G applications.

FIG. 5 illustrates some exemplary traffic characteristics for XR.

FIG. 6 shows a timing diagram that illustrates exemplary discontinuous reception (DRX) operation of a user equipment (UE).

FIG. 7 shows an exemplary ASN.1 data structure for a ConfiguredGrantConfig information element (IE) used for configuration of uplink (UL) configured grants for NR.

FIGS. 8-9 show timing diagrams that illustrate various problems related to conventional DRX operation.

FIG. 10 shows a timing diagram that illustrates performance of various embodiments of the present disclosure relative to conventional DRX operation.

FIGS. 11-12 show timing diagrams that illustrate enhanced DRX operation of various embodiments of the present disclosure.

FIG. 13 illustrates operation of an SP-PDCCH search space having multiple PDCCH monitoring occasions (MOs) per traffic period, according to various embodiments of the present disclosure.

FIG. 14 shows a flow diagram of an exemplary method for a UE (e.g., wireless device), according to various embodiments of the present disclosure.

FIG. 15 shows a flow diagram of an exemplary method for a network node (e.g., base station, eNB, gNB, ng-eNB, etc.) of a wireless network (e.g., NG-RAN, E-UTRAN), according to various embodiments of the present disclosure.

FIG. 16 shows a communication system according to various embodiments of the present disclosure.

FIG. 17 shows a UE according to various embodiments of the present disclosure.

FIG. 18 shows a network node according to various embodiments of the present disclosure.

FIG. 19 shows host computing system according to various embodiments of the present disclosure.

FIG. 20 is a block diagram of a virtualization environment in which functions implemented by some embodiments of the present disclosure may be virtualized.

FIG. 21 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a radio access node or a wireless device.”
Node: As used herein, a “node” can be a network node or a wireless device.
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

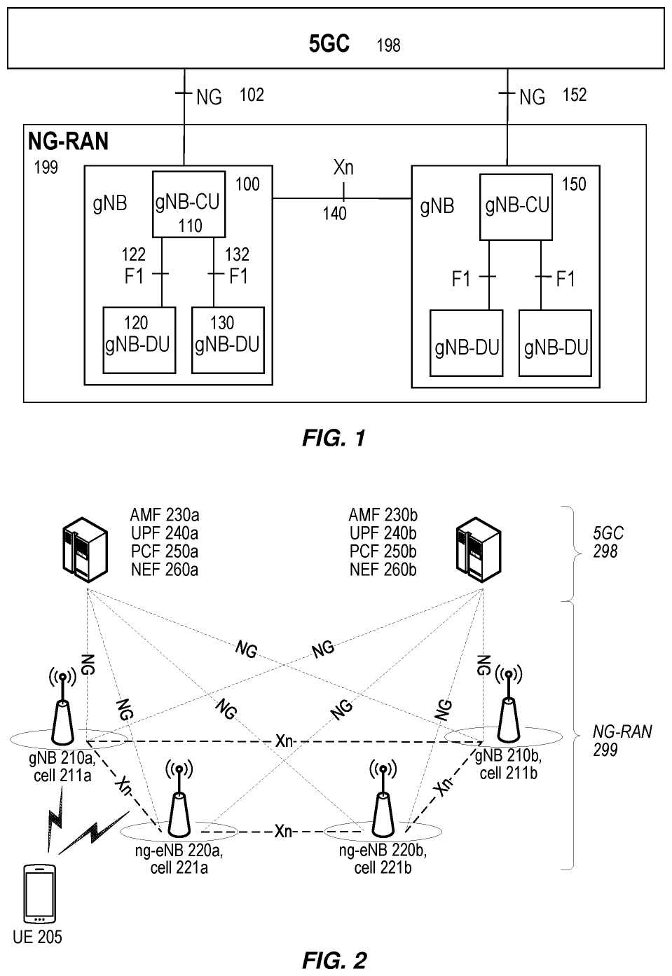

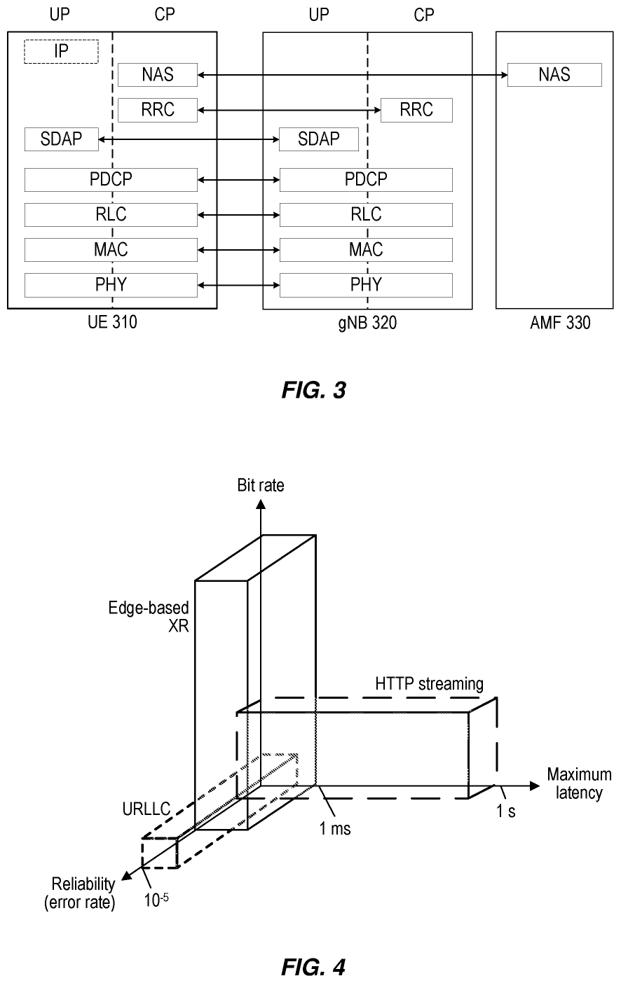

FIG. 3 shows an exemplary configuration of NR user plane (UP) and control plane (CP) protocol stacks between a UE, a gNB, and an AMF, such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. In addition, the Service Data Adaptation Protocol (SDAP) layer handles quality-of-service (QOS) including mapping between QoS flows and Data Radio Bearers (DRBs) and marking QoS flow identifiers (QFI) in UL and DL packets.

When each IP packet arrives, PDCP starts a discard timer. When this timer expires, PDCP discards the associated SDU and the corresponding PDU. If the PDU was delivered to RLC, PDCP also indicates the discard to RLC. The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection. and monitors a paging channel on PDCCH for pages from 5GC via gNB. An NR UE in RRC_IDLE state is not known to the gNB serving the cell where the UE is camping. However. NR RRC includes an RRC_INACTIVE state in which a UE is known (e.g., via UE context) by the serving gNB. RRC_INACTIVE has some properties similar to a “suspended” condition used in LTE.

FIG. 4 illustrates a comparison of various characteristics requirements for XR and other 5G applications. In particular, FIG. 4 shows a comparison of latency, reliability, and bitrate requirements for URLLC, streaming, and EC-based XR. While URLLC services have extreme requirements of 1-ms latency and of 10⁻⁵, EC-based XR can have relaxed requirements 5-10 ms and 10⁻⁴ reliability. However, XR services can require a much higher bite rate than either URLLC or streaming. (e.g., due to codec inefficiency).

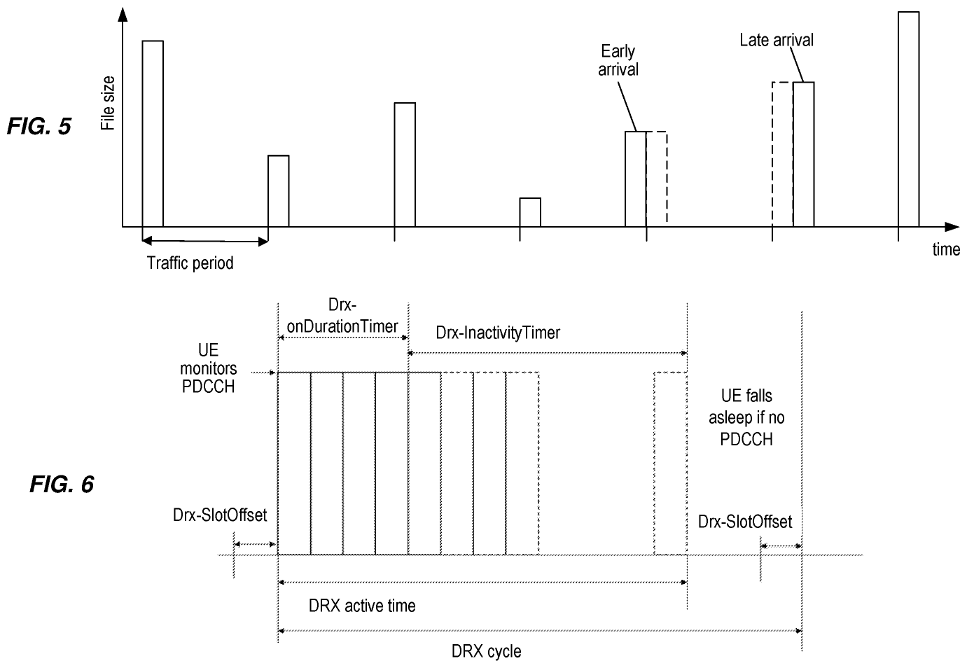

EC-based XR traffic can also be very dynamic, e.g., due to eye/viewport tracking. In general, the traffic can appear to be periodic but with variable file (or packet) sizes, as illustrated in FIG. 5. However, the generally periodic traffic can have occasional timing jitter. This is illustrated in FIG. 5 by early and late arrivals of two packets relative to their expected times based on the traffic period.

When a UE is in RRC_IDLE or RRC_INACTIVE modes, it monitors PDCCH periodically to check for scheduling of paging requests to be subsequently transmitted on physical downlink shared channel (PDSCH). In RRC_CONNECTED mode, a UE monitors PDCCH for scheduling of UL/DL data transmissions (i.e., on PDSCH and physical UL shared channel (PUSCH), respectively) and for other purposes. In between these monitoring occasions, the UE can go to sleep to reduce energy consumption. The amount of UE power savings is related to DRX on duration as a fraction of the entire DRX duty cycle.

This sleep-wake cycle in RRC_CONNECTED mode is also known as DRX or alternately connected DRX (C-DRX) to distinguish it from DRX in RRC_IDLE mode described above. The following discussion relates generally to DRX operations in RRC_CONNECTED mode but the terms “DRX” and “C-DRX” are used interchangeably unless specifically noted otherwise.

FIG. 6 shows a timing diagram that illustrates exemplary DRX operation. The network configures UE DRX parameters and DRX operational mode (e.g., Short DRX and/or Long DRX, a scheme in which initially a short and faster cyclic pattern occurs). At a high level, if the UE successfully decodes a PDCCH, the UE stays awake and starts an inactivity timer supervising a switch back to DRX. If no DCI is received while the inactivity timer is running, UE directly switch to sleep.

In more detail, CDRX operation is based on a DRX cycle, a DRX active time, a DRX-onDurationTimer, a DRX-slotOffset, and a DRX-inactivityTimer. There are defined as follows:
DRX-onDurationTimer: duration at the beginning of a DRX cycle me during which UE waits to receive PDCCH after waking up from DRX. The on duration is a periodic phase which reoccurs with each start of a DRX cycle. This phase defines the minimum average awake time of a UE and can be configured (via RRC) from 1 to 1600 ms. There is only one DRX-onDurationTimer regardless of the DRX operational mode configured at any given time.
DRX-slotOffset: delay from the beginning of a subframe before UE starts the DRX-onDurationTimer. This value can be configured from 0 to 31.
DRX-InactivityTimer(s): duration after occasion in which a PDCCH indicates a new UL or DL transmission for the UE MAC entity. The UE starts the first inactivity timer supervising the switch to DRX when it successfully decodes PDCCH for an initial transmission (not for retransmissions). If short DRX is configured, the UE starts the inactivity timer supervising the switch from short DRX cycles to long DRX cycles when it enters DRX (i.e., at expiry of the first inactivity timer). According to 3GPP TS38.331, this time value can be configured from 0 to 2560 ms. If the UE receives a valid DCI while the DRX-inactivityTimer is running, it extends the timer and continues to monitor PDCCH. If the DRX-inactivityTimer expires, the UE stops PDCCH monitoring and goes to sleep until the end of the current DRX cycle.
DRX active time: The total time during which the UE is awake and monitoring PDCCH, i.e., the duration from the beginning of the DRX on duration until inactivity timer expiration. The minimum active time is equal to the DRX-onDurationTimer value and the maximum is undefined (e.g., infinite).
DRX cycle: The total time of DRX active time and UE sleep time. This is also configurable, e.g., as a trade-off value between reduced UE energy consumption and UE delay requirements. For long DRX cycle this value can vary from 10 to 10240 ms, and for short DRX cycle this value can vary from 2 to 640 ms.

The parameters listed above show a simplified view of the DRX operation. At a more complex level, DRX operation also depends on these additional variables and timers:
DRX-RetransmissionTimerDL (per DL HARQ process except for the broadcast process): the maximum duration until a DL retransmission is received.
DRX-RetransmissionTimerUL (per UL HARQ process): the maximum duration until a grant for UL retransmission is received.
DRX-ShortCycleTimer (optional): the duration the UE shall follow the Short DRX cycle.
DRX-HARQ-RTT-TimerDL (per DL HARQ process except for the broadcast process): the minimum duration before a DL assignment for HARQ retransmission is expected by the MAC entity.
DRX-HARQ-RTT-TimerUL (per UL HARQ process): the minimum duration before a UL HARQ retransmission grant is expected by the MAC entity.
ps-Wakeup (optional): the configuration to start associated drx-on DurationTimer in case DCP is monitored but not detected.
ps-Periodic_CSI_Transmit (optional): the configuration to report periodic channel state information (CSI) during the time duration indicated by drx-onDurationTimer in case DCP is configured but associated drx-onDurationTimer is not started.
ps-TransmitPeriodicL1-RSRP (optional): the configuration to transmit periodic L1-RSRP report(s) during the time duration indicated by drx-onDurationTimer in case DCP is configured but associated drx-onDurationTimer is not started.

UE energy consumption generally varies linearly with the DRX active time, e.g., as a fraction of the DRX cycle. However, reducing the energy consumption by increasing the DRX cycle comes with a cost of delaying the UE's wake-up from sleep, which will increase latency for network-initiated transactions such as paging and handover. Additionally, the performance of all delay-sensitive applications will degrade as the length of DRX sleep increases.

NR data scheduling can be performed dynamically, e.g., on a per-slot basis. In each slot, the base station (e.g., gNB) transmits DCI over PDCCH that indicates which UE is scheduled to receive data in that slot, as well as which RBs will carry that data. A UE first detects and decodes DCI and, if the DCI includes DL scheduling information for the UE, receives the corresponding PDSCH based on the DL scheduling information. DCI formats 1_0 and 1_1 are used to convey PDSCH scheduling.

Likewise, DCI on PDCCH can include UL grants that indicate which UE is scheduled to transmit data on PUCCH in that slot, as well as which RBs will carry that data. A UE first detects and decodes DCI and, if the DCI includes an uplink grant for the UE, transmits the corresponding PUSCH on the resources indicated by the UL grant. DCI formats 0_0 and 0_1 are used to convey UL grants for PUSCH, while Other DCI formats (2_0, 2_1, 2_2 and 2_3) are used for other purposes including transmission of slot format information, reserved resource, transmit power control information, etc.

DCI can also include information about various timing offsets (e.g., slots or subframes) between PDCCH and PDSCH, PUSCH, HARQ, and/or channel state information reference signals (CSI-RS). For example, offset K0 represents the number of slots between the UE's PDCCH reception of a PDSCH scheduling DCI (e.g., formats 1_0 or 1_1) and the subsequent PDSCH transmission. Likewise, offset K1 represents the number of slots between this PDSCH transmission and a responsive UE HARQ ACK/NACK transmission on PUSCH. In addition, offset K3 represents the number of slots between this responsive ACK/NACK and a corresponding retransmission of data on PDSCH. In addition, offset K2 represents the number of slots between the UE's reception of a UL grant DCI (e.g., formats 0_0 or 0_1) on PDCCH and the subsequent PUSCH transmission. Each of these offsets can take on values of zero and positive integers.

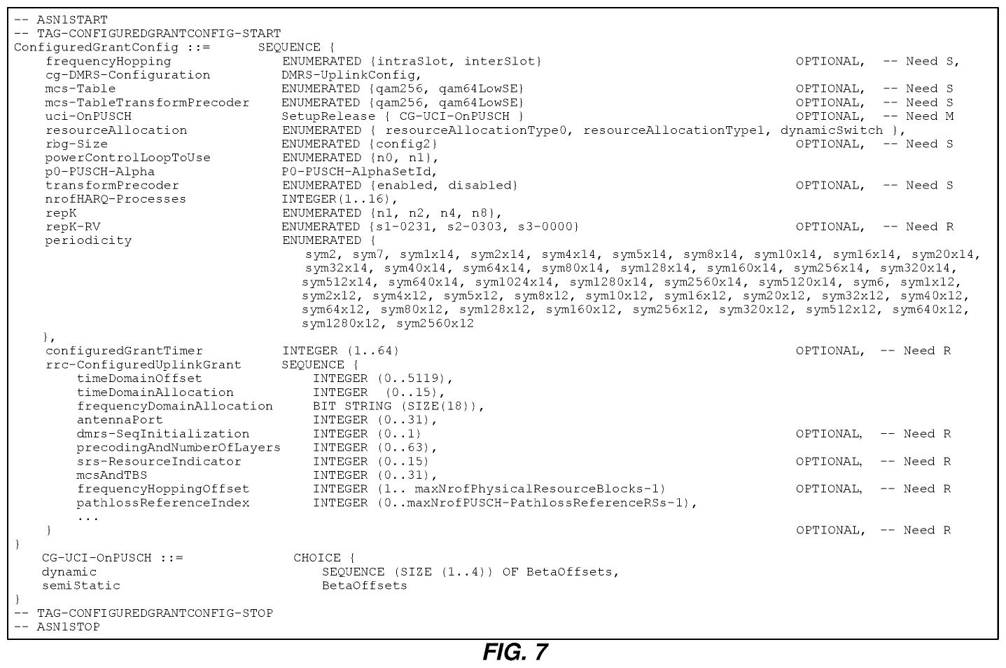

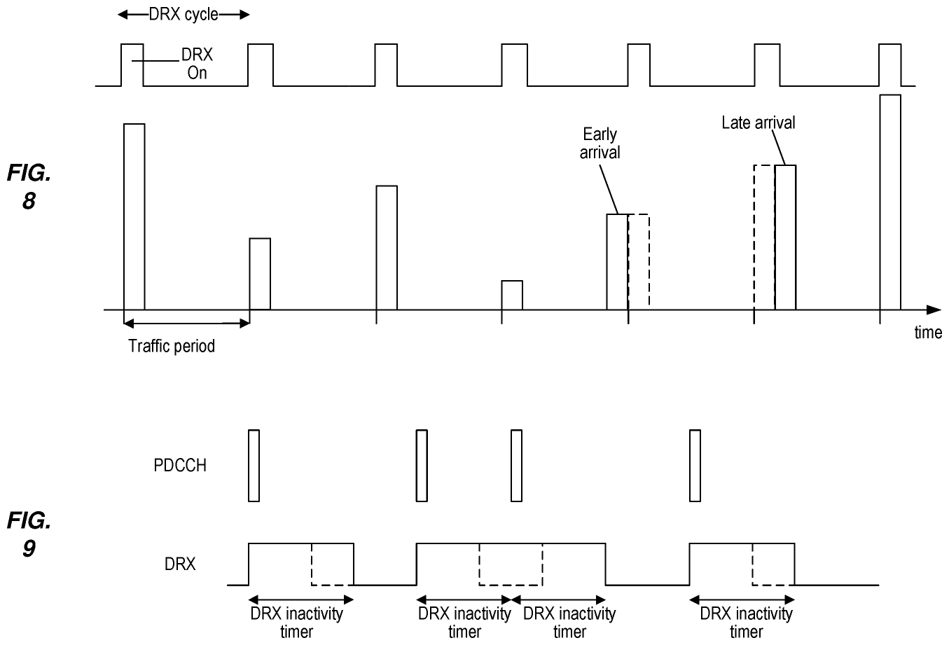

Data transmission can also be scheduled to occur periodically without explicit grants. Such transmissions can be referred to as semi-persistent scheduling (SPS, for DL), configured grant (CG, for UL), or grant-free transmissions. There are two types of configured UL grants for NR. Type-1 are configured via RRC signaling only while for type-2, some parameters are preconfigured via RRC signaling and some parameters are dynamically indicated. FIG. 7 shows an exemplary ASN.1 data structure for a ConfiguredGrantConfig information element (IE) used for RRC configuration of NR type-1 and type-2 UL configured grants. The information in the rrc-ConfiguredUplinkGrant field is Type1-specific. Corresponding information can be provided for type-2 by a configured grant activation DCI, which is scrambled with a configures scheduling radio network temporary identifier (CS-RNTI) assigned to the UE by the network.

As briefly mentioned above, existing techniques for data scheduling are inadequate for services or applications (e.g., XR) that produce periodic, non-deterministic traffic with occasional arrival time jitter, have strict latency requirements, and are run on devices need strict management of energy consumption. This is discussed in more detail below.

Non-dynamic scheduling, based on UL CG and DL SPS, provides predefined resource allocations (e.g., on PUSCH or PDSCH) for a UE to transmit or received a fixed transport block (TB) size. Although it is possible for the network to change a UE's UL CG or DL SPS resource allocation with an activation DCI, these techniques operate at a slower rate than the size variations in the periodic application traffic (e.g., XR), such as illustrated in FIG. 5.

Dynamic scheduling can be used these services or applications. Since a UE is not aware of when a dynamic grant or assignment will be issued by the network, however, it must stay awake to monitor PDCCH for scheduling DCIs. To reduce UE energy consumption, DRX techniques such as illustrated in FIG. 6 restrict the times when a UE is awake, allow the UE to sleep when traffic becomes inactive and remain awake when traffic activity is detected.

Even so, the existing DRX framework is fairly rigid, making it very inefficient for services and applications (e.g., XR) that have strict requirements for low latency, high reliability, and low UE energy consumption. FIG. 8 shows a DRX arrangement in conjunction with the packet arrival timeline shown in FIG. 5. In particular, the UE's periodic DRX on durations are aligned in time with the periodic packet arrivals. However, early or late packet arrivals fall outside of these periodic DRX on durations, i.e., when the UE is asleep. As such, the network can't schedule an untimely packet until a subsequent DRX on duration, causing undesirable latency.

In general, the UE's DRX on durations need to be long enough to handle potential delay jitter. One technique for increasing DRX on durations is illustrated in FIG. 9. The UE starts a drx-InactivityTimer each time it receives a scheduling DCI via PDCCH, and remains awake until expiration of the timer. However, this existing technique does not work well with services and applications (e.g., XR) that have generally periodic, bursty traffic such that no additional bursts arrive while the UE remains awake until expiration of the timer. This causes unnecessary UE energy consumption.

Moreover, since DRX on duration and drx-InactivityTimer are pre-configured and fixed, it is not possible to adjust without additional signaling, which increases delay as discussed above. For example, the DRX on duration cannot be reduced to save energy if burst size is small and does require the UE to remain awake for the full DRX on duration.

In general, to support XR traffic, DRX on duration needs to be aligned with the time when potential grant/assignment DCI is sent on PDCCH and drx-ShortCycleTime/drx-LongCycleTime needs to be aligned with service burst inter-arrival time, which can be very short in XR (e.g., 5-10 ms). DRX on duration needs to be very short for UE energy consumption requirements, which might not be always practical because of the traffic arrival uncertainty (i.e., jitter) and network behavior uncertainty. The latter is mainly due to variation in timing of grants or assignments based on network load. For example, in high-load scenarios, grants and/or assignments may be delayed in favor of scheduling a higher-priority UE. Since DRX configuration is not dynamically adjusted, however, the only conventional way that a UE can address the variation of scheduling for generally-periodic traffic (e.g., in FIG. 8) is to increase DRX on duration-which comes at the expense of increased UE energy consumption.

Additionally, drx-InactivityTimer is preconfigured via RRC signaling and independent of actual traffic burst size. As shown in FIG. 9, it starts from the time a scheduling DCI is received and potentially prolonged if another scheduling DCI is received while the timer is running. It is not designed for generally periodic, bursty traffic scenarios in which it is very unlikely that new data arrives before the timer expires. More importantly, the drx-InactivityTimer is fixed and non-adjustable except by further RRC signaling.

One possible technique is to set a very short drx-InactivityTimer and try to prolong it by sending additional dynamic scheduling DCIs during times of increased data volume. However, issuing a dynamic grant or assignment within a short window to prolong drx-inactivity Timer is risky because the target UE might not receive the scheduling DCI due to PDCCH mis-detection error. In this scenario, the network will lose DRX state synchronization with UE, with the network assuming the UE is in a (prolonged) DRX on duration while the UE has returned to sleep after expiration of the timer without receiving another scheduling DCI.

As such, drx-InactivityTimer needs to set long enough for the gNB to decide whether to issue a follow-up grant or assignment for continuation transmission. For example, for UL data transmissions, drx-InactivityTimer should be greater than UE PDCCH decoding time for scheduling DCI and subsequent UL PUSCH transmission. Likewise, for DL data transmissions, drx-InactivityTimer should be greater than UE PDCCH+PDSCH decoding time and subsequent UE HARQ transmission on PUCCH or PUSCH. Put differently, drx-InactivityTimer shall be longer than one HARQ round-trip time (RTT).

Another possible technique is for the network to send the UE a MAC control element (CE) containing a command for early termination of DRX on duration and drx-Inactivity Timer before timer expiration. To avoid extra signaling, the command could be sent during scheduled DL data transmission. However, the UE requires time to decode such information and act accordingly. According to 3GPP TS 38.214 (v16.7.0), with 30 kHz sub-carrier spacing (SCS), a UE with processing capability “1” takes at least 10 symbols to decode a PDSCH transmission. That implies that it would take at least more than one slot (e.g., 14 symbols) to stop a timer for DRX on duration. This delay mitigates any energy consumption improvements due to the early termination.

Additionally, some time-critical services have very short burst inter-arrival time (e.g., traffic periods) and low packet delay budgets. Due to the various factors discussed above, it may be infeasible to use conventional DRX for these services. As a result, it may be difficult or technically infeasible to implement these services on UEs that store relatively small amounts of energy (e.g., AR glasses).

Accordingly, embodiments of the present disclosure provide flexible and efficient techniques for semi-persistent PDCCH (SP-PDCCH) transmissions for which the UE is not required to follow preconfigured DRX patterns, which reduces UE energy consumption for the types of services or applications discussed above. For example, SP-PDCCH can be differentiated from conventional PDCCH based on various parameters, such as different RNTIs, different search spaces, etc.

For example, the network can configure a new SP-PDCCH search space that can be activated/modified with different control channel elements (CCEs) semi-persistently for a UE and/or service whose data traffic is generally periodic but non-deterministic. The network sends a dynamic scheduling DCI (with UL grant or DL assignment) in the configured SP-PDCCH search space. The UL grant or DL assignment can dynamically allocate resources based on varying packet sizes, such as illustrated in FIGS. 5 and 8. From the network perspective, a UE can be expected to be awake at the SP-PDCCH monitoring occasions (MOs) regardless of DRX state. In some embodiments, the UE can be awake for a period specified in a DCI with a grant or assignment transmitted on SP-PDCCH, e.g., as part of or together with the resource allocation of the grant or assignment. For example, if the grant or assignment indicates a PUSCH or PDSCH allocation from slots (or symbols) l to l+k. If no valid PUSCH/PDSCH is decoded correctly by the UE, the UE can fall to sleep after t≥0 slots (or symbols). When t=0, UE will fall to sleep immediately after PDCCH decoding; when t>0, the UE can remain awake for and monitor the same SP-PDCCH search space for other grants or assignments.

In some embodiments, to capture potential jitter, SP-PDCCH can be configured with period p, offset t, and duration d (e.g., in slots). When d is larger than 1, multiple consecutive SP-PDCCHs are configured. In some embodiments, to reduce UE energy consumption, SP-PDCCH monitoring can be terminated when a valid assignment or grant is detected.

Embodiments can provide various benefits and/or advantages. For example, such techniques can support data traffic (e.g., XR) having strict latency requirements with generally periodic packet arrival times and but varied packet size. Moreover, these techniques can reduce UE energy consumption for such traffic, e.g., by optimizing the amount of time the UE is awake (e.g., to a symbol level). Additionally, these techniques can reduce PDCCH and MAC CE overhead to optimize DRX operations dynamically and allocate resource for varying application packet size. More generally, these techniques can facilitate more efficient usage of available transmission resources (e.g., frequency spectrum), energy-efficient UE operation via DRX, and improved quality-of-experience for users of various applications (including XR and cloud gaming applications) due to reduced UL or DL transmission latency.

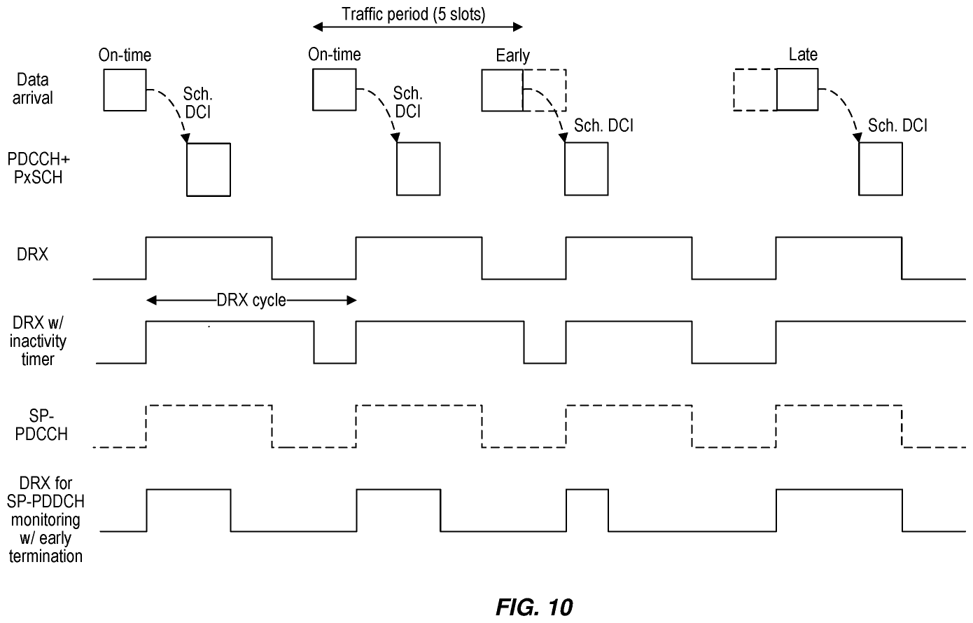

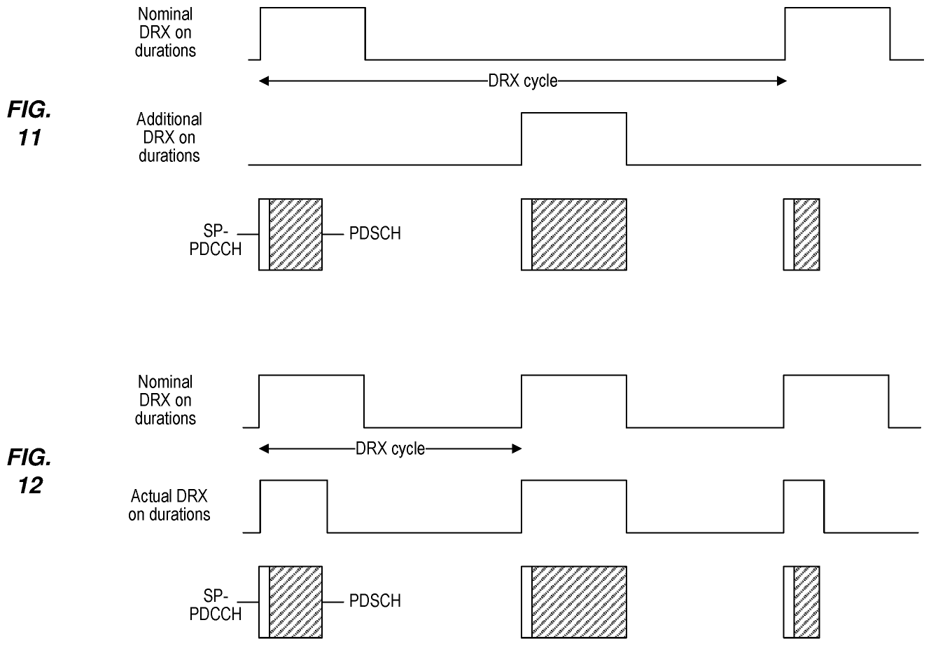

FIG. 10 shows a timing diagram that illustrates performance of various embodiments of the present disclosure relative to conventional DRX operation. In this example, traffic arrival period is five (5) slots with jitter, such that occasionally packets arrived one slot earlier or later than the expected packet arrival time. In addition, scheduling DCIs are sent on PDCCH with a one-slot delay after traffic arrival and it is assumed for simplicity that scheduled PDSCH or PUSCH (collectively “PxSCH”) is completed in the same slot as the scheduling DCI.

The line labeled “DRX” shows a conventional a three-slot DRX on duration with drx-drx-ShortCycleTime/drx-LongCycleTime that is configured to accommodate the +/−1 slot arrival jitter. The line “DRX w/inactivity timer” shows DRX on duration using two-slot drx-InactivityTimer used to reduce UE energy consumption. In other words, when a PDCCH assignment or grant detected, the UE remains awake for the following two slots.

In this example, SP-PDCCH is configured with three (3) slots length and five (5) slot periodicity to accommodate +/−1 slot arrival jitter with minimal delay. SP-PDCCH with early termination SP-PDCCH if a grant/assignment is received is also plotted in the figure. The UE will remain awake for the entire SP-PDCCH duration (i.e., three slots) unless a scheduling DCI is detected, in which case the UE can return to sleep immediately (i.e., after that slot) without monitoring the remaining slots of that SP-PDCCH MO.

In the example shown in FIG. 10, the UE's awake time with conventional DRX scheme with inactivity timer is ˜76%. With SP-PDCCH, the UE's awake time is reduced to ˜57% and the UE's awake time with early monitoring termination of SP-PDCCH is ˜33%. This example illustrates that embodiments can achieve significant reductions in UE energy consumption due to PDCCH monitoring.

Embodiments are described in more detail below. In general, this description is of new UE and/or network behaviors related to a new type of PDCCH monitoring configuration, referred to as “semi-persistent PDCCH” or “SP-PDCCH”. In particular, the description identifies some added flexibility of SP-PDCCH configuration and potential dynamic adjustment, UE behavior in monitoring SP-PDCCH when it is configured in connection with DRX, and new rules related to how UE monitors SP-PDCCH candidates. Note that the term “SP-PDCCH” is only exemplary and used as a convenient notation for a PDCCH that has different characteristics and/or behavior than conventional PDCCH, in accordance with embodiments described herein.

Some of the new UE DRX behaviors related to SP-PDCCH monitoring can also be applied to legacy PDCCH. Additionally, some of the new UE DRX behaviors associated with SP-PDCCH monitoring can be used individually or jointly.

In some embodiments, a UE can be provided with an SP-PDCCH configuration that includes SP-PDCCH monitoring occasions (MOs) during which the UE monitors SP-PDCCH regardless of the UE's configured DRX state. In other words, when the UE if configured with SP-PDCCH MOs that occur outside of the UE's periodic DRX on durations, the UE is expected to wake up (or remain awake) for monitoring SP-PDCCH spaces during those SP-PDCCH MOs. To be clear, this UE behavior is different from conventional UE behavior in which a UE does not monitor PDCCH outside of the UE's periodic DRX on durations.

FIG. 11 shows a timing diagram that illustrate enhanced UE DRX operation according to these embodiments. The top line shows the nominal periodic DRX on durations for the UE, and the middle line shows additional DRX on durations for the UE that are outside of the nominal periodic DRX on durations. During each of these DRX on durations, the UE monitors SP-PDCCH and, if a scheduling DCI is detected, receives the scheduled PDSCH transmissions from the network.

In order to enable the UE to receive the SP-PDCCH outside of the nominal periodic DRX on durations, the UE should be configured via RRC, e.g., with a pattern of additional MOs that the UE should monitor for SP-PDCCH. This can be in the form of a separate search space for SP-PDCCH in which the new monitoring behavior is applied. This allows for implementation of a lightweight sleeping keeping only the minimum components activated to receive the SP-PDCCH.

In some embodiments, if a UE receives a scheduling DCI during an SP-PDCCH MO, it will not activate drx-InactivityTimer regardless of the DRX state. Note that this is different from the conventional behavior in which the UE will activate drx-Inactivity Timer when the UE receives PDCCH during a DRX on duration.

In some embodiments, if a UE receives a scheduling DCI during an SP-PDCCH MO, the UE is expected to receive or transmit PDSCH or PUSCH scheduled by the scheduling DCI. This is done regardless of the UE's DRX configuration and regardless of whether SP-PDCCH is received during or outside of the nominal periodic DRX on durations.

In other embodiments, if a UE receives a scheduling DCI during an SP-PDCCH MO that occurs during one of the periodic DRX on durations, the UE activates drx-InactivityTimer as in conventional behavior. On the other hand, if the UE receives a scheduling DCI during an SP-PDCCH MO that occurs outside of the periodic DRX on durations, the UE activates a new timer that causes the UE to stay awake to receive or transmit the scheduled PDSCH or PUSCH. Alternately, the UE remains awake at least until it has completed the reception or transmission of the corresponding scheduled PDSCH or PUSCH.

In some embodiments, the SP-PDCCH can be associated with a specific RNTI, such that the UE can differentiate SP-PDCCH from conventional PDCCH. In some embodiments, the SP-PDCCH can be associated with a different search space type or a different index than conventional PDCCH.

In some embodiments, one or more DRX parameters such as DRX on duration can be dynamically adjusted based on SP-PDCCH MOs. For example, when a UE receives a scheduling DCI via SP-PDCCH during a DRX on duration, the UE remains awake until the end of the scheduled PDSCH or PUSCH and the returns to sleep even if the DRX on duration has not been completed. In other words, that DRX on duration is reduced to the end of the scheduled PDSCH or PUSCH. FIG. 12 shows a timing diagram that illustrate enhanced DRX operation according to these embodiments.

In these embodiments, the dynamic adjustment of one or more DRX parameters such as DRX on duration can be activated or indicated by any of the following: a field in the scheduling DCI transmitted on SP-PDCCH; a specific RNTI used to scramble a CRC of the scheduling DCI; or a specific SP-PDCCH search space or index.

In other embodiments, when the UE receives a scheduling DCI via SP-PDCCH and the UE's configured DRX on duration is longer than the scheduled PDSCH/PSUCH allocation, the UE can ignore the configured DRX on duration to save energy. This can be seen as different from DRX parameter adjustment since the originally configured DRX parameters will be valid in subsequent DRX on durations-just not in the current DRX on duration. In other words, receiving a scheduling DCI via SP-PDCCH during a configured DRX on duration triggers the UE to behave differently during that DRX on duration. In some embodiments, the UE can decide whether or not to activate drx-InactivityTimer based on the PDSCH/PUSCH resource allocation received in the scheduling DCI via SP-PDCCH. For example, if the resource allocation of PDSCH/PUSCH indicated by SP-PDCCH is within the configured DRX on duration, there is no need to extend the DRX on duration and the UE refrains from doing so.

In other embodiments, the network can also dynamically indicate which SP-PDCCH is used to let a UE ignore DRX parameters. This indication can be either by including new bits in a scheduling DCI or by a specific RNTI used for scrambling. For example, if a UE receives a scheduling DCI without such indication, the UE follows the configured DRX parameters. On the other hand, if the UE receives a scheduling DCI with such indication, the UE does not follow the configured DRX parameters and instead terminates the configured DRX on duration early and/or refrains from activating the configured drx-InactivityTimer.

In some embodiments, SP-PDCCH MOs can be configured in a specific search space identified by a specific search space type, index, or tag. In each MO, a UE can be expected to simultaneously monitor both conventional PDCCH candidate (e.g., one carrying DCI with CRC scrambled by C-RNTI) and SP-PDCCH candidate (e.g., one carrying DCI with CRC scrambled by the new RNTI for SP-PDCCH). If conventional PDCCH is received, the conventional PDCCH based DRX procedure is followed, e.g., drx-InactivityTimer is started. If SP-PDCCH is received, the new procedures described in this invention disclosure applies, e.g., no drx-InactivityTimer is triggered even if it happens during the DRX On duration.

In some embodiments, SP-PDCCH candidates are associated with a DCI format that has a CRC scrambled by a specific RNTI. In each MO, the UE can concurrently monitor for both conventional PDCCH candidate (e.g., containing DCI with CRC scrambled by C-RNTI) and SP-PDCCH candidates (e.g., containing DCI with CRC scrambled by X-RNTI, where X is a nominal placeholder). The UE applies different DRX behaviors depending on which type of PDCCH candidate is received during a MO.

In some embodiments, SP-PDCCH MOs can be semi-statically configured for a UE with one or more parameters such as PDCCH monitoring period and/or offset (e.g., in slots or symbols), which can also be dynamically adjusted. For example, the dynamic adjustment can be done through an indication in MAC CE or DCI. The UE applies the semi-static configuration of SP-PDCCH monitoring period and/or offset until it receives the indication for dynamic adjustment, after which it applies the adjusted values. The timing for the UE to apply the adjusted values can be indicated together with the dynamic adjustment, part of the semi-static configuration, or pre-configured/specified.

In some embodiments, the SP-PDCCH MOs can be configured as part of a new UE-specific or cell-specific search space type. In some embodiments, the new UE-specific or cell-specific search space type can be associated with a DCI format with CRC scrambled by a new RNTI (e.g., X-RNTI).

In some embodiments, the configuration of SP-PDCCH MOs and corresponding parameters can be activated/deactivated dynamically. In this case, the UE starts or stops monitoring SP-PDCCH candidates once the configuration is activated or deactivated, respectively. In some embodiments, the dynamic activation and/or deactivation can be done by an indication included in MAC CE, scheduling DCI, or a dedicated activation/deactivation DCI.

In some embodiments, the network can provide a UE with an SP-PDCCH monitoring configuration having multiple MOs per traffic period. This configuration can be arranged by the network such that at least one of the UE's SP-PDCCH MOs aligns with timing of a scheduling DCI for actual traffic arrival considering jitter. This can prevent and/or reduce scheduling delays for traffic having these characteristics.

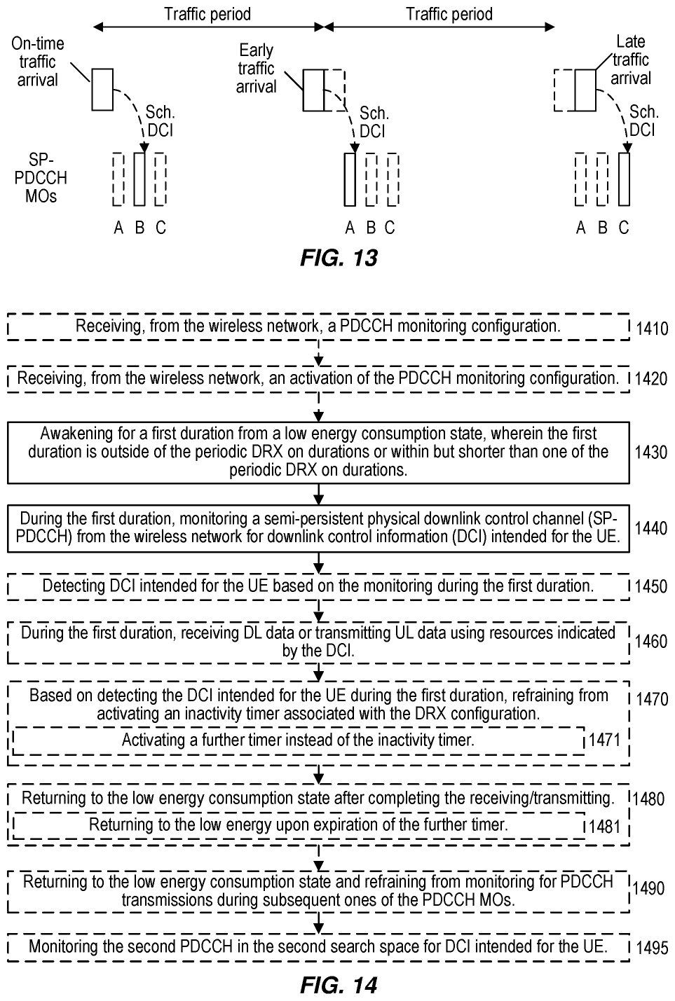

FIG. 13 illustrates operation of an SP-PDCCH search space having multiple PDCCH MOs per traffic period, according to these embodiments. On-time traffic arrival will result in a scheduling DCI during the middle (“B”) SP-PDCCH MO, early traffic arrival will result in a scheduling DCI during the early (“A”) SP-PDCCH MO, and late traffic arrival will result in a scheduling DCI during the late (“C”) SP-PDCCH MO. The UE monitors all three of the SP-PDCCH MOs to account for the variation of scheduling DCI due to traffic arrival jitter. The multiple MOs can be considered part of an SP-PDCCH search space.

One drawback of this approach is higher UE energy consumption due to increased PDCCH monitoring. This can be mitigated by the UE skipping subsequent MOs (e.g., B and C) of a traffic period when it receives a scheduling DCI during an earlier MO (e.g., A) of the traffic period.

In some of these embodiments, the SP-PDCCH search space configuration can include the traffic period. In addition, the multiple MOs within a traffic period can be configured by the following parameters: offset, to indicate a start of the MOs relative to the start of the traffic period; period, to indicate a gap between consecutive MOs within the traffic period; and duration, to indicate the duration of multiple PDCCH MO within the traffic period. These parameters can be in units of slots or symbols.

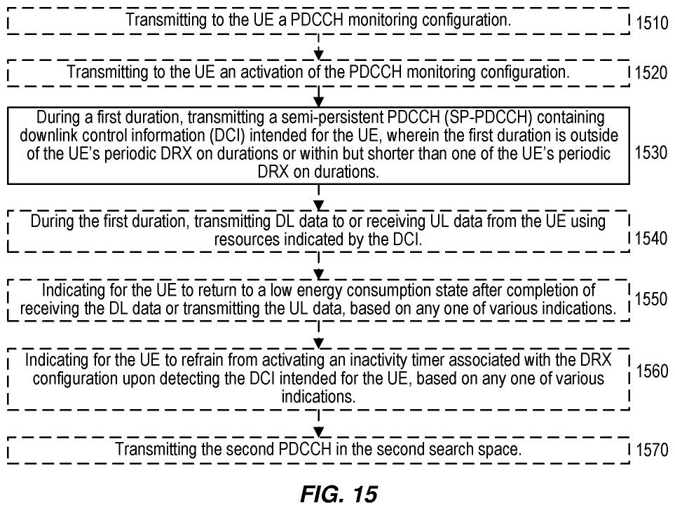

Various features of the embodiments described above correspond to various operations illustrated in FIGS. 14-15, which show exemplary methods (e.g., procedures) for a UE and a network node, respectively. In other words, various features of the operations described below correspond to various embodiments described above. Furthermore, the exemplary methods shown in FIGS. 14-15 can be used cooperatively to provide various exemplary benefits described herein. Although FIGS. 14-15 show specific blocks in particular orders, the operations of the exemplary methods can be performed in different orders than shown and can be combined and/or divided into blocks having different functionality than shown. Optional blocks or operations are indicated by dashed lines.

In particular, FIG. 14 shows an exemplary method (e.g., procedure) for a UE configured to operate in a wireless network according to a DRX configuration that includes periodic DRX on durations, according to various embodiments of the present disclosure. The exemplary method can be performed by a UE (e.g., wireless device, IoT device, etc.) such as described elsewhere herein.

The exemplary method can include the operations of block 1430, where the UE can awaken for a first duration from a low energy consumption state. The first duration is outside of the periodic DRX on durations (e.g., as illustrated in FIG. 11), or within but shorter than one of the periodic DRX on durations (e.g., as illustrated in FIG. 12). The exemplary method can also include the operations of block 1440, where during the first duration, the UE can monitor a SP-PDCCH from the wireless network for DCI intended for the UE.

In some embodiments, the monitoring in block 1440 is performed on a first search space associated with a SP-PDCCH. In some of these embodiments, the first search space is distinct from a second search space associated with a second PDCCH that is not a SP-PDCCH. In such case, the exemplary method also includes the operations of block 1495, where the UE monitors the second PDCCH in the second search space for DCI intended for the UE. In different variants, the monitoring in block 1495 can be performed according to one of the following:
during the first duration, which is within but shorter than one of the UE's periodic DRX on durations; or
during the periodic DRX on durations, with the first duration being outside of the periodic DRX on durations.

In some embodiments, the exemplary method can also include the operations of block 1450, where the UE can detect DCI intended for the UE based on the monitoring during the first duration in block 1440. In some of these embodiments, the exemplary method can also include the operations of blocks 1460 and 1480, where during the first duration, the UE can receive DL data or transmit UL data using resources indicated by the DCI and return to the low energy consumption state after completion of receiving DL data or transmitting UL data in accordance with the DCI.

In some of these embodiments, returning to the low energy consumption state in block 1480 after completion of the receiving or transmitting in block 1460 is based on a first condition being met. The first condition is one of the following:
a CRC of the DCI is scrambled by an RNTI associated with SP-PDCCH;
the DCI is detected in a search space associated with SP-PDCCH; or
a field in the DCI that indicates for the UE to return to the low energy consumption state after completion of receiving DL data or transmitting UL data in accordance with the DCI.

In some variants of these embodiments, when the first condition is not met, the first duration is at least as long as one of the periodic DRX on durations. In some variants of these embodiments, the exemplary method can also include the operations of block 1470, where based on detecting the DCI during the first duration, the UE can refrain from activating an inactivity timer associated with the DRX configuration. In some further variants, refraining from activating the inactivity timer is further based on a second condition being met, with the second condition being one of the following:
the first duration is outside of the periodic DRX on durations,
a CRC of the DCI is scrambled by an RNTI associated with SP-PDCCH,
the DCI is detected in a search space associated with SP-PDCCH, or
a field in the DCI that indicates for the UE to refrain from activating the inactivity timer.

In some further variants, refraining from activating an inactivity timer associated with the DRX configuration in block 1470 can include the operations of sub-block 1471, where the UE can activate a further timer instead of the inactivity timer associated with the DRX configuration. In such case, returning to the low energy consumption state in block 1480 after completion of the receiving or transmitting can include the operations of sub-block 1481, where the UE can return to the low energy upon expiration of the further timer.

In some further variants, the first duration includes a plurality of PDCCH monitoring occasions (MOs) and the DCI intended for the UE is detected during an initial one of the PDCCH MOs. Also, the exemplary method also includes the operations of block 1490, where the UE can return to the low energy consumption state and refrain from monitoring the SP-PDCCH during subsequent one or more of the PDCCH MOs.

In some further variants, the plurality of PDCCH MOs include at least the following:
a first PDCCH MO corresponding to timing of DCI that schedules data traffic that arrives early relative to a traffic period;
a second PDCCH MO corresponding to timing of DCI that schedules data traffic that arrives on-time relative to the traffic period; and
a third PDCCH MO corresponding to timing of DCI that schedules data traffic that arrives late relative to the traffic period.
   FIG. 13 shows an example of these variants.

In some further variants, the exemplary method can also include the operations of block 1410, where the UE can receive from the wireless network a PDCCH monitoring configuration including indications of one or more of the following:
a traffic period between successive arrivals of data traffic scheduled by PDCCH;
an offset of an initial PDCCH MO from the start of each traffic period;
a gap between successive PDCCH MOs within each traffic period; and
a duration of the plurality of PDCCH MOs within each traffic period.
   In such variants, monitoring during the first duration in block 1440 can be based on the PDCCH monitoring configuration.

In some variants, the exemplary method can also include the operations of block 1420, where the UE can receive, from the network node, an activation of the PDCCH monitoring configuration. The monitoring during the first duration (e.g., in block 1440) is further based on the activation. Put differently, the activation of the PDCCH monitoring configuration by the network node triggers the UE's monitoring according to the PDCCH monitoring configuration. In some further variants, the activation can be received via the DCI detected (e.g., in block 1450) via the monitoring, or via a MAC CE.

In addition, FIG. 15 shows an exemplary method (e.g., procedure) for a network node of a wireless network to communicate with a UE configured to operate according to a DRX configuration comprising periodic DRX on durations, according to various embodiments of the present disclosure. The exemplary method can be performed by a network node (e.g., base station, eNB, gNB, ng-eNB, etc., or component thereof) such as described elsewhere herein.

The exemplary method can include the operations of block 1530, where during a first duration, the network node can transmit a SP-PDCCH containing DCI intended for the UE. The first duration is outside of the UE's periodic DRX on durations (e.g., as illustrated in FIG. 11), or within but shorter than one of the UE's periodic DRX on durations (e.g., as illustrated in FIG. 12).

In some embodiments, the SP-PDCCH containing the DCI intended for the UE is transmitted in a first search space associated with an SP-PDCCH. In some of these embodiments, the first search space is distinct from a second search space associated with a second PDCCH that is not a SP-PDCCH and the exemplary method also includes the operations of block 1570, where the network node can transmit the second PDCCH in the second search space. In different variants, the second PDCCH is transmitted according to one of the following:
during the first duration, which is within but shorter than one of the UE's periodic DRX on durations; or
during the periodic DRX on durations, with the first duration being outside of the UE's periodic DRX on durations.

In some embodiments, the DCI indicates resources for UE reception of DL data or UE transmission of UL data, and the exemplary method also includes the operations of block 1570, where during the first duration, the network node can transmit DL data to or receive UL data from the UE using the resources indicated by the DCI.

In some of these embodiments, the exemplary method can also include the operations of block 1550, where the network node can indicate for the UE to return to a low energy consumption state after completion of the receiving or transmitting, which can be based on one of the following:
a CRC of the DCI is scrambled by an RNTI associated with SP-PDCCH;
the DCI is detected in a search space associated with SP-PDCCH; or
an indication in a field of the DCI.

In other of these embodiments, the exemplary method can also include the operations of block 1560, where the network node can indicate for the UE to refrain from activating an inactivity timer associated with the DRX configuration upon detecting the DCI, based on one of the following:
the first duration is outside of the periodic DRX on durations,
a CRC of the DCI is scrambled by an RNTI associated with SP-PDCCH,
the DCI is detected in a search space associated with SP-PDCCH, or
an indication in a field of the DCI.

In other of these embodiments, the first duration includes a plurality of PDCCH MOs, including at least the following:
a first PDCCH MO corresponding to timing of DCI that schedules data traffic that arrives early relative to a traffic period;
a second PDCCH MO corresponding to timing of DCI that schedules data traffic that arrives on-time relative to the traffic period; and
a third PDCCH MO corresponding to timing of DCI that schedules data traffic that arrives late relative to the traffic period.

In some variants of these embodiments, the exemplary method can also include the operations of block 1510, where the network node can transmit to the UE a PDCCH monitoring configuration including indications of one or more of the following:
a traffic period between successive arrivals of data traffic scheduled by PDCCH;
an offset of an initial PDCCH MO from the start of each traffic period;
a gap between successive PDCCH MOs within each traffic period; and
a duration of the plurality of PDCCH MOs within each traffic period.
   In such variants, transmitting SP-PDCCH during the first duration (e.g., in block 1530) can be based on the PDCCH monitoring configuration.
   In some further variants, the exemplary method can also include the operations of block 1520, where the network node can transmit to the UE an activation of the PDCCH monitoring configuration. The transmitting during the first duration (e.g., in block 1530) is further based on the activation. Put differently, the activation of the PDCCH monitoring configuration by the network node triggers the UE's monitoring according to the PDCCH monitoring configuration, such that the network node can transmit the DCI with knowledge that the UE will be monitoring for it. In some further variants, the activation can be transmitted via the DCI (e.g., in block 1530), or via a MAC CE.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

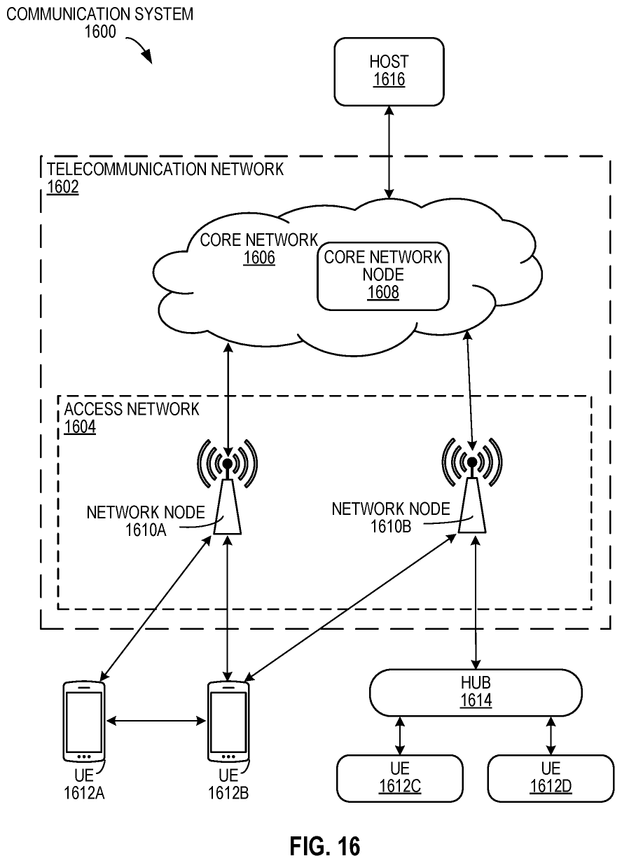

FIG. 16 shows an example of a communication system 1600 in accordance with some embodiments. In this example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3GPP access node or non-3GPP access point. The network nodes 1610 facilitate direct or indirect connection of UEs, such as by connecting UEs 1612a-d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

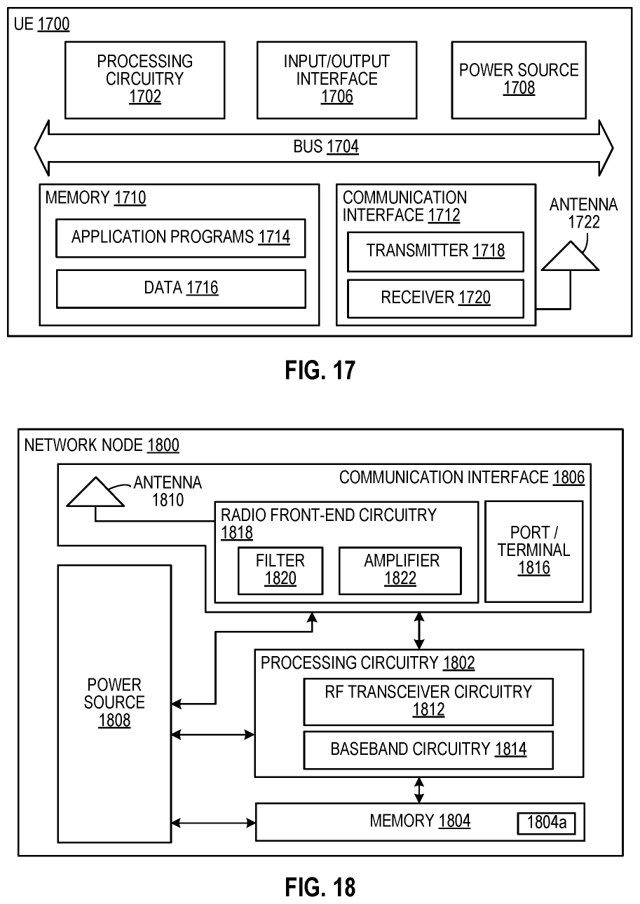

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd

Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an

Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. Examples of network nodes include access points (APs) (e.g., radio access points), base stations (e.g., radio base stations, Node Bs, eNBs, gNBs, etc.), and core network nodes (e.g., that host CN functions).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio

Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions (collectively denoted computer program product 1804a) capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

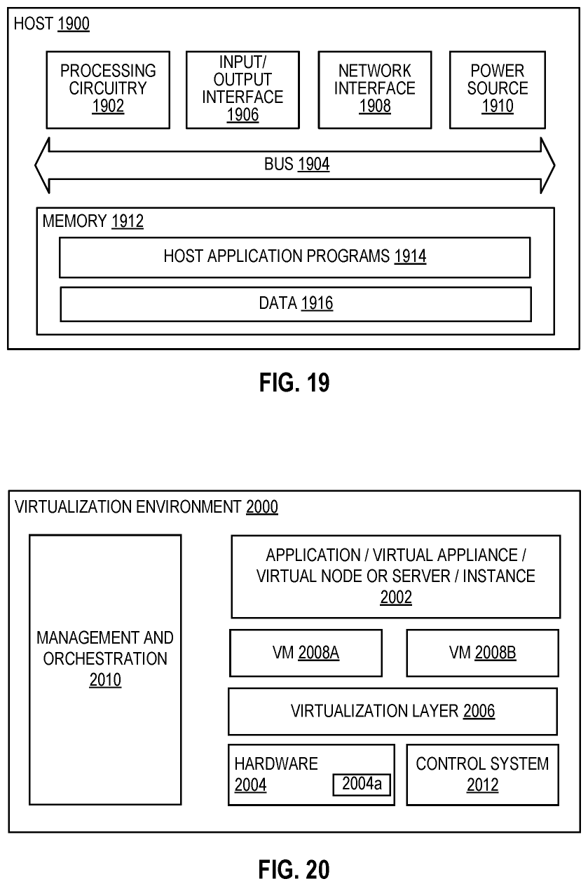

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions (collectively denoted computer program product 2004a) executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g., such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

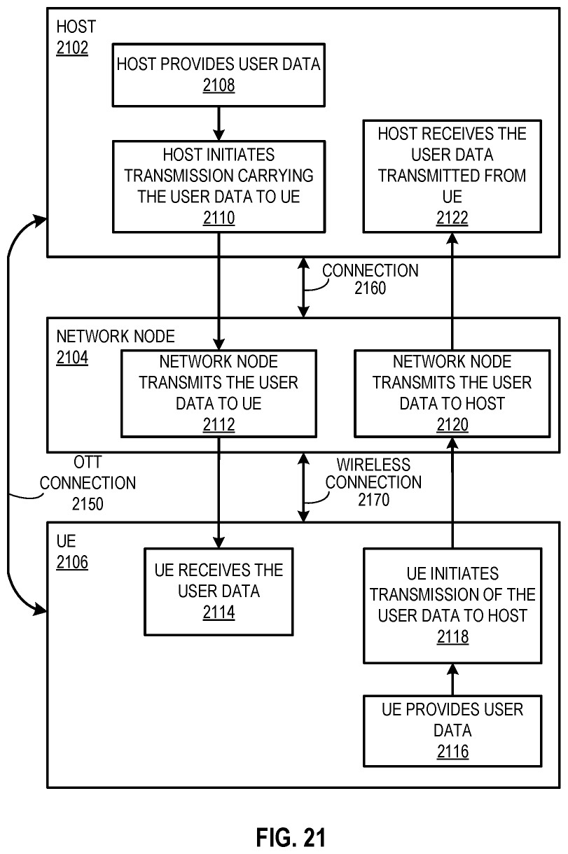

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results.

The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Various embodiments described herein can improve the performance of OTT services provided to the UE 2106 using the OTT connection 2150, in which the wireless connection 2170 forms the last segment. For example, embodiments described herein can support data traffic having strict latency requirements with generally periodic packet arrival times and but varied packet size. Moreover, embodiments can reduce UE energy consumption for such traffic, e.g., by optimizing the amount of time the UE is awake. Additionally, embodiments can reduce PDCCH and/or MAC CE overhead to optimize DRX operations dynamically and allocate resources for varying application packet size. More generally, these techniques can facilitate more efficient usage of available transmission resources, energy-efficient UE operation via DRX, and improved quality-of-experience (QoE) for users of various OTT applications or services (e.g., XR and cloud gaming) due to reduced UL or DL transmission latency. These improvements increase value of OTT applications or services to end users and service providers.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured to operate in a wireless network according to a discontinuous reception (DRX) configuration comprising periodic DRX on durations, the method comprising:
   awakening for a first duration from a low energy consumption state, wherein the first duration is one of the following: outside of the periodic DRX on durations, or within but shorter than one of the periodic DRX on durations; and
   during the first duration, monitoring for physical downlink control channel (PDCCH) transmissions from a network node in the wireless network.
A2. The method of embodiment A1, wherein the monitoring is performed on a first search space associated with a semi-persistent PDCCH (SP-PDCCH).
A2a. The method of embodiment A2, wherein the first search space is distinct from a second search space associated with a conventional PDCCH, and the method further comprises monitoring for conventional PDCCH in the second search space.
A2b. The method of embodiment A2a, wherein one of the following applies:
   the first duration is within but shorter than one of the UE's periodic DRX on durations, and the monitoring for conventional PDCCH is performed during the first duration; or
   the first duration is outside of the periodic DRX on durations, and the monitoring for conventional PDCCH is performed during the periodic DRX on durations.
A3. The method of any of embodiments A1-A2b, further comprising detecting downlink control information (DCI) intended for the UE based on the monitoring.
A4. The method of embodiment A3, further comprising:
   during the first duration, receiving or transmitting data using resources indicated by the DCI; and
   returning to the low energy consumption state after completion of the receiving or transmitting.
A4a. The method of embodiment A4, wherein returning to the low energy consumption state after completion of the receiving or transmitting is selective based on a first condition being met, wherein the first condition is one of the following:
   a cyclic redundancy check (CRC) of the DCI is scrambled by a radio network temporary identifier (RNTI) associated with semi-persistent PDCCH (SP-PDCCH);
   the DCI is detected in a search space associated with SP-PDCCH; or
   a field in the DCI that indicates for the UE to return to the low energy consumption state after completion of the receiving or transmitting.
A4b. The method of embodiment A4a, wherein when the first condition is not met, the first duration is at least as long as one of the periodic DRX on durations.
A5. The method of any of embodiments A3-A4a, further comprising, based on detecting the DCI during the first duration, refraining from activating an inactivity timer associated with the DRX configuration.
A6. The method of embodiment A5, wherein refraining from activating the inactivity timer is further based on a second condition being met, wherein the second condition is one of the following:
   the first duration is outside of the periodic DRX on durations,
   a cyclic redundancy check (CRC) of the DCI is scrambled by a radio network temporary identifier (RNTI) associated with semi-persistent PDCCH (SP-PDCCH),
   the DCI is detected in a search space associated with SP-PDCCH, or
   a field in the DCI that indicates for the UE to refrain from activating the inactivity timer.
A7. The method of any of embodiments A5-A6, wherein:
   the method further comprises, upon detecting the DCI during the first duration, activating a further timer instead of the inactivity timer associated with the DRX configuration; and
   returning to the low energy consumption state after completion of the receiving or transmitting comprises returning to the low energy upon expiration of the further timer.
A8. The method of embodiment A3, wherein:
   the first duration includes a plurality of PDCCH monitoring occasions (MOs);
   the DCI is detected during a first one of the PDCCH MOs; and
   the method further comprises returning to the low energy consumption state and refraining from monitoring for PDCCH transmissions during subsequent ones of the PDCCH MOs.
A9. The method of embodiment A8, wherein the plurality of PDCCH MOs include at least the following:
   a first PDCCH MO corresponding to timing of downlink control information (DCI) that schedules data traffic that arrives early relative to a traffic period;
   a second PDCCH MO corresponding to timing of DCI that schedules data traffic that arrives on-time relative to the traffic period; and
   a third PDCCH MO corresponding to timing of DCI that schedules data traffic that arrives late relative to the traffic period.
A10. The method of any of embodiments A8-A9, further comprising receiving, from a network node in the wireless network, a PDCCH monitoring configuration including indications of one or more of the following:
   a traffic period between successive arrivals of data traffic scheduled by PDCCH;
   an offset of an initial PDCCH MO from the start of each traffic period;
   a gap between successive PDCCH MOs within each traffic period; and
   a duration of the plurality of PDCCH MOs within each traffic period.
A11. The method of embodiment A10, wherein the monitoring during the first duration is based on the PDCCH monitoring configuration.
A12. The method of embodiment A11, further comprising receiving, from the network node, an activation of the PDCCH monitoring configuration, wherein the monitoring during the first duration is further based on the activation.
A13. The method of embodiment A12, wherein the activation is received in one of the following: the DCI detected based on the monitoring, or a medium access control (MAC) control element (CE).
B1. A method for a network node of a wireless network to communicate with a user equipment (UE) configured to operate according to a discontinuous reception (DRX) configuration comprising periodic DRX on durations, the method comprising:
   during a first duration, transmitting a physical downlink control channel (PDCCH) containing downlink control information (DCI) intended for the UE, wherein the first duration is outside of the UE's periodic DRX on durations or within but shorter than one of the UE's periodic DRX on durations.
B2. The method of embodiment B1, wherein PDCCH containing the DCI is transmitted in a first search space associated with a semi-persistent PDCCH (SP-PDCCH).
B2a. The method of embodiment B2, wherein the first search space is distinct from a second search space associated with a conventional PDCCH, and the method further comprises transmitting conventional PDCCH in the second search space.
B3. The method of embodiment B2a, wherein one of the following applies:
   the first duration is within but shorter than one of the UE's periodic DRX on durations, and the conventional PDCCH is transmitted in the second search space during the first duration; or
   the first duration is outside of the UE's periodic DRX on durations, and the conventional PDCCH is transmitted in the second search space during the periodic DRX on durations.
B4. The method of any of embodiments B1-B3, wherein:
   the DCI indicates resources for UE reception of downlink (DL) data or UE transmission of uplink (UL) data; and
   the method further comprises, during the first duration, transmitting or receiving data using the resources indicated by the DCI.
B5. The method of embodiment B4, further comprising indicating for the UE to return to a low energy consumption state after completion of the receiving or transmitting, based on one of the following:
   a cyclic redundancy check (CRC) of the DCI is scrambled by a radio network temporary identifier (RNTI) associated with semi-persistent PDCCH (SP-PDCCH);
   the DCI is detected in a search space associated with SP-PDCCH; or
   a field in the DCI that indicates for the UE to return to the low energy consumption state after completion of the receiving or transmitting.
B6. The method of embodiment B4, further comprising indicating for the UE to refrain from activating an inactivity timer associated with the DRX configuration upon detecting the DCI, based on one of the following:
   the first duration is outside of the periodic DRX on durations,
   a cyclic redundancy check (CRC) of the DCI is scrambled by a radio network temporary identifier (RNTI) associated with semi-persistent PDCCH (SP-PDCCH),
   the DCI is detected in a search space associated with SP-PDCCH, or
   a field in the DCI that indicates for the UE to refrain from activating the inactivity timer.
B7. The method of embodiment B4, wherein:
   the first duration includes a plurality of PDCCH monitoring occasions (MOs);
   the DCI is transmitted during a one of the PDCCH MOs.
B8. The method of embodiment B7, wherein the plurality of PDCCH MOs include at least the following:
   a first PDCCH MO corresponding to timing of DCI that schedules data traffic that arrives early relative to a traffic period;
   a second PDCCH MO corresponding to timing of DCI that schedules data traffic that arrives on-time relative to the traffic period; and
   a third PDCCH MO corresponding to timing of DCI that schedules data traffic that arrives late relative to the traffic period.
B9. The method of any of embodiments B7-B8, further comprising transmitting, to the UE, a PDCCH monitoring configuration including one or more of the following:
   a traffic period between successive arrivals of data traffic scheduled by PDCCH;
   an offset of an initial PDCCH MO from the start of each traffic period;
   a gap between successive PDCCH MOs within each traffic period; and
   a duration of the plurality of PDCCH MOs within each traffic period.
B10. The method of embodiment B9, wherein the transmitting during the first duration is based on the PDCCH monitoring configuration.
B11. The method of embodiment B10, further comprising transmitting, to the UE, an activation of the PDCCH monitoring configuration, wherein the transmitting during the first duration is further based on the activation.
B12. The method of embodiment B11, wherein the activation is transmitted in one of the following: the DCI detected based on the monitoring, or a medium access control (MAC) control element (CE).
C1. A user equipment (UE) configured to operate in a wireless network according to a discontinuous reception (DRX) configuration comprising periodic DRX on durations, the UE comprising:
   radio transceiver circuitry configured to communicate with a network node in the wireless network; and
   processing circuitry operatively coupled to the radio transceiver circuitry, whereby the processing circuitry and the radio transceiver circuitry are configured to perform operations corresponding to any of the methods of embodiments A1-A13.
C2. A user equipment (UE) configured to operate in a wireless network according to a discontinuous reception (DRX) configuration comprising periodic DRX on durations, the UE being further arranged to perform operations corresponding to any of the methods of embodiments A1-A13.
C3. A non-transitory, computer-readable medium storing computer-executable instructions that, when executed by processing circuitry of a user equipment (UE) configured to operate in a wireless network according to a discontinuous reception (DRX) configuration comprising periodic DRX on durations, configure the UE to perform operations corresponding to any of the methods of embodiments A1-A13.
C4. A computer program product comprising computer-executable instructions that, when executed by processing circuitry of a user equipment (UE) configured to operate in a wireless network according to a discontinuous reception (DRX) configuration comprising periodic DRX on durations, configure the UE to perform operations corresponding to any of the methods of embodiments A1-A13.
D1. A network node arranged to communicate with a user equipment (UE) configured to operate in a wireless network according to a discontinuous reception (DRX) configuration comprising periodic DRX on durations, the network node comprising:
   radio network interface circuitry configured to communicate with the UE; and
   processing circuitry operatively coupled to the radio network interface circuitry, whereby the processing circuitry and the radio network interface circuitry are configured to perform operations corresponding to any of the methods of embodiments B1-B12.
D2. A network node arranged to communicate with a user equipment (UE) configured to operate in a wireless network according to a discontinuous reception (DRX) configuration comprising periodic DRX on durations, the network being further arranged to perform operations corresponding to any of the methods of embodiments B1-B12.
D3. A non-transitory, computer-readable medium storing computer-executable instructions that, when executed by processing circuitry of a network node arranged to communicate with a user equipment (UE) configured to operate in a wireless network according to a discontinuous reception (DRX) configuration comprising periodic DRX on durations, configure the network node to perform operations corresponding to any of the methods of embodiments B1-B12.
D4. A computer program product comprising computer-executable instructions that, when executed by processing circuitry of a network node arranged to communicate with a user equipment (UE) configured to operate in a wireless network according to a discontinuous reception (DRX) configuration comprising periodic DRX on durations, configure the network node to perform operations corresponding to any of the methods of embodiments B1-B12.

1.-31. (canceled)

32. A method for a user equipment (UE) configured to operate in a wireless network according to a discontinuous reception (DRX) configuration comprising periodic DRX on durations, the method comprising:
awakening for a first duration from a low energy consumption state, wherein the first duration is one of the following: outside of the periodic DRX on durations, or within but shorter than one of the periodic DRX on durations; and
during the first duration, monitoring a semi-persistent physical downlink control channel (SP-PDCCH) from the wireless network for downlink control information (DCI) intended for the UE.

33. The method of claim 32, wherein:
the monitoring is performed in a first search space associated with SP-PDCCH;
the first search space is distinct from a second search space associated with a second PDCCH that is not a SP-PDCCH; and
the method further comprises monitoring the second PDCCH in the second search space for DCI intended for the UE.

34. The method of claim 33, wherein monitoring the second PDCCH in the second search space is performed according to one of the following:
during the first duration, which is within but shorter than one of the UE's periodic DRX on durations; or
during the periodic DRX on durations, and the first duration is outside of the periodic DRX on durations.

35. The method of claim 32, further comprising:
during the first duration, detecting DCI intended for the UE based on the monitoring;
during the first duration, receiving downlink (DL) data or transmitting uplink (UL) data using resources indicated by the DCI; and
returning to the low energy consumption state after completion of receiving DL data or transmitting UL data in accordance with the DCI.

36. The method of claim 35, wherein:
returning to the low energy consumption state after completion of receiving DL data or transmitting UL data is based on a first condition being met; and
the first condition is one of the following:
a cyclic redundancy check (CRC) of the DCI is scrambled by a radio network temporary identifier (RNTI) associated with SP-PDCCH;
the DCI is detected in a search space associated with SP-PDCCH; or
a field in the DCI that indicates for the UE to return to the low energy consumption state after completion of receiving DL data or transmitting UL data in accordance with the DCI.

37. The method of claim 36, wherein when the first condition is not met, monitoring the SP-PDCCH is performed at least until the end of a periodic DRX on duration that includes the first duration.

38. The method of claim 36, further comprising, based on detecting the DCI intended for the UE during the first duration, refraining from activating an inactivity timer associated with the DRX configuration.

39. The method of claim 38, wherein:
refraining from activating the inactivity timer is further based on a second condition being met; and
the second condition is one of the following:
the first duration is outside of the periodic DRX on durations,
a cyclic redundancy check (CRC) of the DCI is scrambled by a radio network temporary identifier (RNTI) associated with SP-PDCCH,
the DCI is detected in a search space associated with SP-PDCCH, or
a field in the DCI that indicates for the UE to refrain from activating the inactivity timer.

40. The method of claim 38, wherein:
refraining from activating an inactivity timer associated with the DRX configuration comprises activating a further timer instead of the inactivity timer associated with the DRX configuration; and
returning to the low energy consumption state after completion of receiving DL data or transmitting UL data comprises returning to the low energy upon expiration of the further timer.

41. The method of claim 40, wherein:
the first duration includes a plurality of PDCCH monitoring occasions (MOs);
the DCI intended for the UE is detected during an initial one of the PDCCH MOs; and
the method further comprises returning to the low energy consumption state and refraining from monitoring the SP-PDCCH during subsequent one or more of the PDCCH MOs.

42. The method of claim 41, wherein the plurality of PDCCH MOs include at least the following:
a first PDCCH MO corresponding to timing of DCI that schedules data traffic that arrives early relative to a traffic period;
a second PDCCH MO corresponding to timing of DCI that schedules data traffic that arrives on-time relative to the traffic period; and
a third PDCCH MO corresponding to timing of DCI that schedules data traffic that arrives late relative to the traffic period.

43. The method of claim 41, further comprising receiving from the wireless network a PDCCH monitoring configuration including indications of one or more of the following:
a traffic period between successive arrivals of data traffic scheduled by PDCCH;
an offset of an initial PDCCH MO from the start of each traffic period;
a gap between successive PDCCH MOs within each traffic period; and
a duration of the plurality of PDCCH MOs within each traffic period.

44. A method for a network node of a wireless network to communicate with a user equipment (UE) configured to operate according to a discontinuous reception (DRX) configuration comprising periodic DRX on durations, the method comprising:
during a first duration, transmitting a semi-persistent physical downlink control channel (SP-PDCCH) containing downlink control information (DCI) intended for the UE, wherein the first duration is one of the following: outside of the UE's periodic DRX on durations, or within but shorter than one of the UE's periodic DRX on durations.

45. The method of claim 44, wherein:
the SP-PDCCH containing the DCI intended for the UE is transmitted in a first search space associated with an SP-PDCCH;
the first search space is distinct from a second search space associated with a second PDCCH that is not a SP-PDCCH; and
the method further comprises transmitting the second PDCCH in the second search space.

46. The method of claim 45, wherein the second PDCCH is transmitted in the second search space according to one of the following:
during the first duration, which is within but shorter than one of the UE's periodic DRX on durations; or
during the periodic DRX on durations, and the first duration is outside of the UE's periodic DRX on durations.

47. The method of claim 44, wherein:
the DCI indicates resources for UE reception of downlink (DL) data or UE transmission of uplink (UL) data; and
the method further comprises, during the first duration, transmitting DL data to or receiving UL data from the UE using the resources indicated by the DCI.

48. The method of claim 47, further comprising indicating for the UE to return to a low energy consumption state after completion of receiving the DL data or transmitting the UL data, based on one of the following:
a cyclic redundancy check (CRC) of the DCI is scrambled by a radio network temporary identifier (RNTI) associated with SP-PDCCH;
the DCI is detected in a search space associated with SP-PDCCH; or
an indication in a field of the DCI.

49. The method of claim 47, further comprising indicating for the UE to refrain from activating an inactivity timer associated with the DRX configuration upon detecting the DCI intended for the UE, based on one of the following:
the first duration is outside of the periodic DRX on durations;
a cyclic redundancy check (CRC) of the DCI is scrambled by a radio network temporary identifier (RNTI) associated with SP-PDCCH;
the DCI is detected in a search space associated with SP-PDCCH; or
an indication in a field of the DCI.

50. The method of claim 47, wherein the first duration includes a plurality of PDCCH monitoring occasions, MOs, including at least the following:
a first PDCCH MO corresponding to timing of DCI that schedules data traffic that arrives early relative to a traffic period;
a second PDCCH MO corresponding to timing of DCI that schedules data traffic that arrives on-time relative to the traffic period; and
a third PDCCH MO corresponding to timing of DCI that schedules data traffic that arrives late relative to the traffic period.

51. The method of claim 50, further comprising transmitting to the UE a PDCCH monitoring configuration including one or more of the following:
a traffic period between successive arrivals of data traffic scheduled by PDCCH;
an offset of an initial PDCCH MO from the start of each traffic period;
a gap between successive PDCCH MOs within each traffic period; and
a duration of the plurality of PDCCH MOs within each traffic period.

52. User equipment (UE) configured to operate in a wireless network according to a discontinuous reception (DRX) configuration comprising periodic DRX on durations, the UE comprising:
communication interface circuitry configured to communicate with a network node in the wireless network; and
processing circuitry operatively coupled to the communication interface circuitry, whereby the processing circuitry and the communication interface circuitry are configured to:
awaken for a first duration from a low energy consumption state, wherein the first duration is one of the following: outside of the periodic DRX on durations, or within but shorter than one of the periodic DRX on durations; and
during the first duration, monitor a semi-persistent physical downlink control channel (SP-PDCCH) from the wireless network for downlink control information (DCI) intended for the UE.

53. A network node arranged to communicate with user equipment (UE) configured to operate in a wireless network according to a discontinuous reception (DRX) configuration comprising periodic DRX on durations, the network node comprising:
communication interface circuitry configured to communicate with the UE; and
processing circuitry operatively coupled to the communication interface circuitry, whereby the processing circuitry and the communication interface circuitry are configured to perform the method of claim 44.
